(19) United States
(12) Patent Application Publication
(10) Pub. No.: US 2007/0153081 A1
(43) Pub. Date: Jul. 5, 2007

(54) Method and apparatus for initiating support request from mobile station

(76) Inventor: Peter Borislavov Manchev, Sofia (BG)

Correspondence Address: PETER B. MANCHEV, 41 SOLUN STR., APT. 15, SOFIA, 1680, BG

(21) Appl. No.: 11/306,485

(22) Filed: Dec. 29, 2005

(51) Int. Cl. H04N 7/14

(52) U.S. Cl. 348/14.01

(57) ABSTRACT

Method and apparatus for initiating support request from mobile station by providing a digital image generated at the mobile station to a support center. The digital image is created upon pressing a preconfigured key combination and could be stored on the mobile station. Signals representative of the created digital image is automatically sent to the support center after confirmation from the mobile station operator. Once received at the support center, the digital image is stored for evidentiary purposes. After that the mobile station operator have to contact the support center in order to complete the support initiation process by providing information regarding his support request and asking that the support center use already received digital image as evidence for this support request. If the mobile station operator does not contact the support center within contractually predetermined time period, the support request is considered abandoned. This invention could be used to create new insurance products and services.

### FIELD OF INVENTION

The present invention relates in general to support centers, such as insurance company support center, security company support center, etc., and more specifically to a method for initiating a support request. In particular, the present invention relates to apparatus, and an associated method for initiating support request from mobile station by providing a digital image, or a series of digital images, to a support center and communicating with the support center, providing information regarding initiator's support request and asking that the support center use already received digital image as evidence for this support request, in order to complete the support initiation process. This invention could be used to create new insurance products and services.

### BACKGROUND OF INVENTION

Mobile stations, such as mobile phones, personal digital assistants (PDA), etc., capable of creating digital images, could be utilized in many ways.

If a method could be provided to utilize the digital imaging capabilities of mobile station, the digital image, or series of digital images, could be provided as evidence material to the support center during the process of initiating a support request and resolving the request.

### SUMMARY OF THE INVENTION

The present invention advantageously provides method and apparatus, by which to provide a support center, such as insurance company support center in which support requests are routed, with data generated at a mobile station at which the support request is originated.

Through operation of an embodiment of the present invention, a manner is provided by which automatically to provide a digital image to the support center after confirmation from the mobile station operator. A single digital image can be provided. Or, a plurality of digital images, such as those generated pursuant to a multimedia transmission, can be provided.

In one aspect of the present invention, a mobile station operator starts a support request by creating a digital image by pressing a preconfigured key combination. The digital image could be stored on the mobile station. A dedicated actuation key is sometimes provided at the mobile station instead of or in addition to a preconfigured key combination. After confirmation from the mobile station operator, signals representative of the created digital image is automatically sent to the support center. Once received at the support center, the digital image is stored for evidentiary purposes. After that the mobile station operator have to contact the support center in order to complete the support initiation process by providing information regarding his support request and asking that the support center use already received digital image as evidence for this support request.

In another aspect of present invention, the digital image is associated with the mobile station and could be identified as being generated and submitted from this mobile station to the support center. The support center could track the received requests by identifying them as submitted by a particular mobile station. When the mobile station operator contacts the support center, all information regarding his support request is associated with one or more submitted by his mobile station digital images. In this way the support center could complete the support initiation process and proceed further with resolving the support request.

In another aspect of the present invention, a digital image is caused to be created by the mobile station upon user actuation of the actuation key or a preconfigured key combination. By providing the digital image to the support center, the personnel at the support center are provided with additional information related to the support request. The digital image may, for instance, be used for evidentiary purposes in insurance claims. By creating a digital image representative of the perpetuator, and then sending the digital image to the support center, the captured digital image is made available to identify the perpetuator.

In another aspect of the present invention, apparatus is provided for the support center to which the digital image is transmitted by the mobile station initiation a support request. Upon establishment of the link with the mobile station, digital image taken at the mobile station, and optionally, a positional information associated with the mobile station are provided to the support center. The digital image is captured, and the positional information provided to the support center, if available, is indexed together with the captured digital image and stored at a storage device at the support center. Additional indicia, such as the time at which the transmission is established and identifying information of the mobile station can also be indexed together with the digital image. By capturing the digital image, the image can later be retrieved and used for evidentiary purposes. Additional information provided by the mobile station operator is also indexed together with the digital image when the mobile station operator contacts the support center and provides such additional information.

Thereby, by operation of an embodiment of the present invention, a digital image is provided to a support center by a mobile station. Moreover the mobile station operator provides additional information to the support center regarding his support request associated with the provided digital image so that the support center can complete the support initiation process.

In these and other aspects, therefore, method and apparatus are provided for a radio communication system having a mobile station selectably operable by a user to initiate a support request to a support center. A digital image is provided to the support center. A digital image creator is coupled to at least receive indications of initiation of support request. The digital image creator creates the digital image responsive to the reception of the indications of support request. A digital image signal generator is coupled to receive indications of the digital image created by the digital image creator. The digital image signal generator generates a digital image signal for transmission to the support center.

A more complete appreciation of the present invention and the scope thereof can be obtained from the accompanying drawings, which are briefly summarized below, the following detailed description of the presently-preferred embodiments of the invention, and the appended claims.

### DESCRIPTION OF THE DRAWINGS

FIG. 1 illustrates a functional block diagram of a communication system in which an embodiment of the present invention is operable.

FIG. 2 illustrates a functional block diagram of a support center operable pursuant to an embodiment of the present invention.

FIG. 3 illustrates a method flow diagram of the method of operation of an embodiment of the present invention.

### DETAILED DESCRIPTION OF THE INVENTION

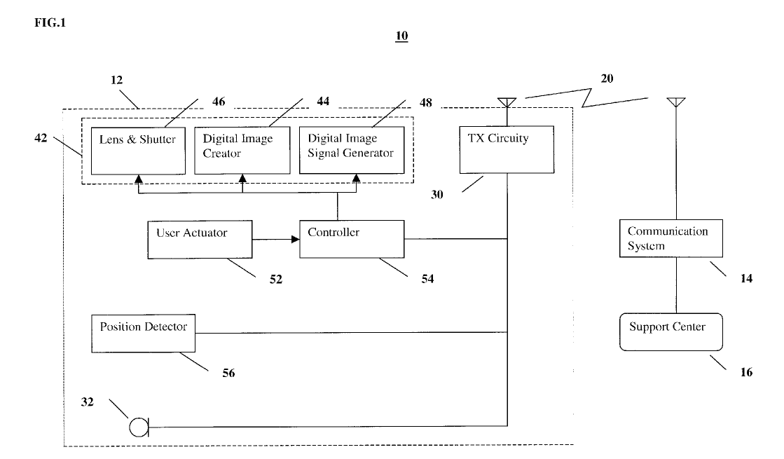

FIG. 1 illustrates a functional block diagram of a radio communication system, shown generally at 10, in which an embodiment of the present invention is operable to provide radio communications with a mobile station 12. In the exemplary implementation shown in the figure, the radio communication system 14 is formed of a digital cellular communication system constructed according to any of various standards promulgated by standard-creating bodies.

Operation of an embodiment of the present invention shall be described with respect to a digital cellular communication system. In other implementations, though, other embodiments of the present invention are analogously operable in other communications systems to initiate support request at support centers.

A communication is formable between the support center 16 and the communication system 14 and, in turn, by way of radio links 20 with the mobile station 12. Two-way communications are permitted between the mobile station 12 and the communication node formed by the support center 16. A user of the mobile station, a “call originator”, is able to originate a support request by pressing a preconfigured key combination.

The mobile station 12 includes a transmit portion, represented by the transmit circuity 30 and optionally includes a receive portion, represented by the receive circuity 34. The transmit circuity 30 is operable to form transmit signals for communication by way of link channels defined upon the radio link 20 to the radio communication system 14.

The mobile station is shown to include a data source 32 coupled to the transmit circuity 30. The data source is here represented by a microphone operable to transmit acoustic signals into electrical form for application to the transmit circuity.

The mobile station of an embodiment of the present invention further includes a digital camera capable of creating digital images. The digital camera includes a digital image creator 44 coupled to a lens and shutter assembly 46. The lens and shutter assembly is operable in conventional manner to pass light energy to be detected by the digital image creator 44 at which a digital image is created. The digital image creator is coupled with to a digital image formatter 46 and signal generator 48. The formatter and signal generator is operable to format a signal representative of the values forming the digital image created by the digital image creator and to provide the signal, once generated, to the transmit circuity 30. The transmit circuity is selectably operable to transmit the digital image signal generated by the signal generator 48. In one implementation, the digital image forms part of a multimedia sequence and the formatter 46 and the signal generator 48 are operable to provide a multimedia sequence to the transmit circuity.

The mobile station also includes a user actuator 52, such as an actuation key actuable by a user of the mobile station. The user actuator, in the exemplary implementation, is formed of a keypad actuation key which, when actuated by the user of the mobile station, initiates a support request procedure to the support center 16. Here, the user actuator 52 is shown to be coupled to the control circuity 54. The control circuity is operable to detect actuation of the user actuator and to generate the necessary actions to initiate the support request. The transmit circuity is operable pursuant to operation set forth in the standard specifications associated with the communication system pursuant to which the communication system 10 is constructed to commence call set-up procedures to establish a communication link between the mobile station and the support center.

The mobile station may optionally include a position detector 56, which is operable to receive position indicia, such as latitudinal and longitudinal coordinates, which are provided to the transmit circuity to be sent to the support center.

During operation, when the user of the mobile station decides to initiate a support request, the user actuates the user actuator 52. Actuation of the user actuator results that the digital camera 42 is operable to create a digital image of a feature proximate to the mobile station and to provide a digital image signal representative thereof to the transmit circuity 30. Position indicial may also be generated at that time by the position detector 56 and provided to the transmit circuity to be communicated to the support center. Other information such as voice or information specific to the mobile station may also be provided to the transmit circuity at that time. A single image can be provided to the support center, or a plurality of images can be provided together with voice communication thereby to provide a streaming video service, such as pursuant to a multimedia service, to the support center.

The digital image is automatically transmitted to the support center upon set-up of the call between the mobile station and the support center. As the digital image is automatically transmitted to the support center, to be used to initiate a support request, and, if appropriate, for evidentiary purposes. Upon action of the user actuator, a multitude of types of situations are reportable to the support center together with a digital image thereof. By providing the digital image to the support center, the personnel of the support center are able to use the digital image in resolving the support request.

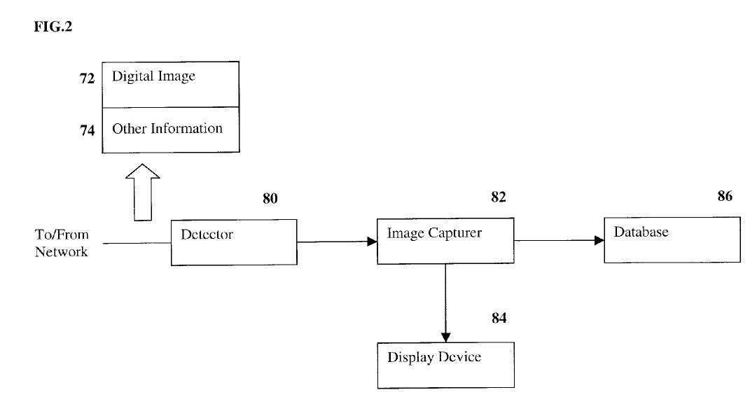

FIG. 2 illustrates functional elements of the support center 16 which forms a node coupled to the radio communication system 14 (shown in FIG.1) upon establishment upon a connection between the mobile station and the support center, as described above, the support center is provided with digital image taken at the mobile station, here indicated by the block 72 and optionally with positional and other information, here indicated by the block 74.

A detector 80 is coupled to receive indications of at least the digital image and other optional information. When values of the digital image are detected, the values are provided to an image capturer 82. The image capturer is formed of a storage device, which permanently stores the values of the digital image. The values of the digital captured and stored image are provided to a display device 84 to display the digital image to personnel at the support center.

The detector is also operable to detect the other optional information sent to the support center and to provide them to the permanent storage 86. The other optional information is provided to the display device to display the optional information to personnel at the support center. In one implementation, the other optional information is overlaid upon the digital image captured by the image capturer and displayed upon the display device.

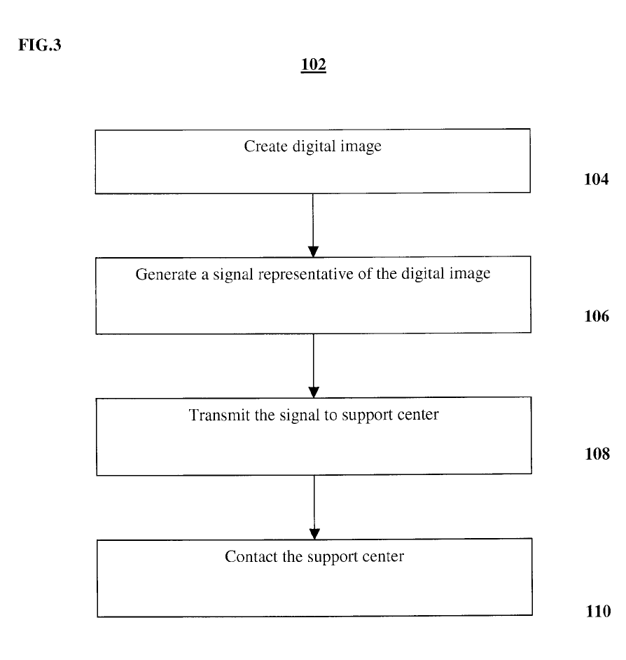

FIG. 3 illustrates a method flow diagram, shown generally at 102, of an embodiment of the present invention. The method 102 provides a digital image generated at the mobile station to a support center.

First, as indicated by the block 104, a digital image is created at the mobile station responsive to user action.

Second, as indicated by the block 106, a digital image signal representative of the digital image is generated. And, as indicated by the block 108 the digital image signal is transmitted to the support center. The digital image, once provided to the support center is used to initiate a support request originating from the mobile station.

Thereby, through operation of an embodiment of the present invention, a manner is provided by which to initiate a support request from mobile station by providing a digital image generated at the mobile station to a support center.

The support request is confirmed by contacting the support center as indicated by the block 110.

The previous descriptions are of preferred examples for implementing the invention, and the scope of the invention should not necessarily be limited by this description. The scope of the present invention is defined by the following claims.

What is claimed is:

1. A method and apparatus for initiating support request from mobile station by providing a digital image, or a series of digital images, generated at the mobile station to a support center, said apparatus comprising: a digital image creator, said digital image creator creates the digital image responsive to the reception of the indications of support request; a digital image signal generator coupled to receive indications of the digital image created by said digital image creator, said digital image signal generator for generating a digital image signal for transmission to the support center.

2. The digital image, or a series of digital images, is created by the apparatus of claim 1 upon pressing a preconfigured key combination by the user actuator.

3. Signals representative of the created digital image of claim 2 are automatically sent to the support center after confirmation from the mobile station operator.

4. The apparatus of claim 1 wherein the call is initiated to initiate support request and wherein said digital image signal generator generates the digital image signal for transmission to the support center.

5. In the method of claim 1, a combination with the support center of further apparatus for operating upon the digital image signal generated by said digital image signal generator, said further apparatus comprising: a detector coupled to receive indications of the digital image signal subsequent to transmission of the digital image signal to the support center; said detector for detecting values of the digital signal; an image capturer coupled to said detector, said image capturer for capturing a visual image responsive to the values of the digital image signal detected by said detector.

6. The further apparatus of claim 5 further comprising a display device coupled to said image capturer, said display device for displaying at the support center the visual image captured by said image capturer.

7. The further apparatus of claim 5 wherein said image capturer comprises a storage device at which the values of the digital image signal detected by said detector are stored.

8. The further apparatus of claim 7 wherein the mobile station is further operable to send other information to the support center and wherein said detector is further operable to detect values of the other information.

9. The apparatus of claim 8 wherein the storage device forming said image capturer further stores the values of the other information.

10. Once the support center receives the digital image, or a series of digital images, the mobile station operator have to contact the support center in order to complete the support initiation process by providing information regarding his support request and confirming that the support center use already received digital image as evidence for this support request.

11. A method for initiating support request from mobile station by providing a digital image to a support center to which a user of a mobile station having a transmit portion and a user actuator selectably initiates a support request from mobile station by providing a digital image, or a series of digital images, generated at the mobile station to a support center, said method comprising: creating a digital image responsive to actuation of the user actuator; automatically generating a digital image signal responsive to the digital image created during said operation of creating; and automatically transmitting, from the transmit position, the digital image signal created during said operation of generating to the support center.
